(19) United States
(12) Patent Application Publication
(10) Pub. No.: US 2011/0015888 A1
(43) Pub. Date: Jan. 20, 2011

(54) MAGNETIC DATA PROCESSING DEVICE, MAGNETIC DATA PROCESSING METHOD, AND MAGNETIC DATA PROCESSING PROGRAM

(75) Inventor: Ibuki Handa, Hamamatsu-shi (JP)

Correspondence Address: Dickstein Shapiro LLP, 2049 Century Park East, Suite 700, Los Angeles, CA, 90067, US

(73) Assignee: Yamaha Corporation, Hamamatsu-Shi (JP)

(21) Appl. No.: 12/831,203

(22) Filed: Jul. 6, 2010

(30) Foreign Application Priority Data
Jul. 16, 2009 (JP) 2009-167814

(51) Int. Cl. G01C 17/38

(52) U.S. Cl. 702/92; 702/179

(57) ABSTRACT

In a magnetic data processing device, an accumulation part repeatedly accumulates a predetermined number of magnetic data to provide a statistical population, while sequentially acquiring magnetic data output from a 3D magnetic sensor. A determination part determines, when the predetermined number of magnetic data is accumulated as a statistical population, whether or not the statistical population is spread two-dimensionally using a first threshold, and determines, when the statistical population is spread two-dimensionally, whether or not an angle between a first plane and a second plane is small to a negligible extent using a second threshold, the first plane including a circle about which the statistical population is concentrated, and the second plane being perpendicular to a line segment connecting a center of the circle and a current offset of the magnetic data. An offset update part updates the current offset based on the statistical population so that the current offset moves in a direction parallel to the first plane as a result of updating, in case that the statistical population is spread two-dimensionally and the angle between the first plane and the second plane is not small to the negligible extent.

### BACKGROUND OF THE INVENTION

1. Technical Field of the Invention

The present invention relates to a magnetic data processing device, a magnetic data processing method, and a magnetic data processing program, and more particularly to offset updating of three-dimensional Earth magnetic data.

2. Description of the Related Art

A conventional three-dimensional (3D) Earth magnetic sensor is mounted on a movable body such as a mobile phone to detect the direction of the Earth's magnetic field. When a magnetic data processing device derives orientation based on magnetic data, the device needs to perform a process for correcting the magnetic data to eliminate measurement errors caused by magnetization of the movable body. A control value used for this correction process is derived based on a plurality of magnetic data and is referred to as an “offset”.

However, the magnetic data includes not only offset components caused by magnetization of the movable body but also error components caused by magnetic fields generated by electronic circuits mounted in the movable body or caused by fluctuations of outputs of the magnetic sensor according to Gaussian distribution. Accordingly, to correctly derive a true offset caused by magnetization of the movable body, there is a need to store a plurality of magnetic data that are spread three-dimensionally over a wide range on a sphere. However, since special movement is required for the movable body to store such magnetic data, it is generally necessary for the user to perform an operation causing the movable body to make such a special movement. Since the true offset varies irregularly, the difference between the offset derived by the magnetic data processing device and the actual offset is likely to increase unless the user frequently performs such an operation.

The present inventor has previously created an invention capable of maintaining an offset close to the true offset without requiring the user to perform such a special operation (see Japanese Patent Application Publication No. 2007-240270). Japanese Patent Application Publication No. 2007-240270 describes a method in which an offset is derived three-dimensionally based on a statistical population of magnetic data when the distribution of the magnetic data of the statistical population is three-dimensional and an offset is derived two-dimensionally based on a statistical population of magnetic data when the distribution of the magnetic data of the statistical population is two-dimensional. In the case where the magnetic data of the statistical population is not spread three-dimensionally, this method two-dimensionally corrects, if the magnetic data of the statistical population is spread two-dimensionally, an offset for a direction parallel to a plane in which the magnetic data is spread two-dimensionally.

According to the prior art described in Japanese Patent Application Publication No. 2007-240270, when the magnetic sensor is rotating about a specific axis, two-dimensional offset correction is repeated since magnetic data is spread two-dimensionally. However, since the magnetic data includes error components caused by magnetic fields generated by electronic circuits mounted in the movable body or caused by fluctuations of outputs of the magnetic sensor according to Gaussian distribution or the like, a plane about which the statistical population is concentrated is perturbed even when the magnetic sensor rotates about a specific axis. As a result, the prior art described in Japanese Patent Application Publication No. 2007-240270 has a problem in that the offset is corrected in a direction perpendicular to the plane about which the statistical population is concentrated even though the offset should not be corrected in the direction perpendicular to the plane.

### SUMMARY OF THE INVENTION

The invention has been made to overcome the above problem and it is an object of the present invention to prevent, when a three-dimensional magnetic sensor is rotating about a specific axis, an offset of magnetic data from being inappropriately corrected due to correction of the offset of magnetic data in the direction of the specific axis.

(1) A magnetic data processing device for achieving the above object comprising: an accumulation part that repeatedly accumulates a predetermined number of magnetic data to provide a statistical population, the predetermined number being four or greater, while sequentially acquiring magnetic data output from a three-dimensional (3D) magnetic sensor; a determination part that determines, when the predetermined number of magnetic data is accumulated as a statistical population, whether or not the statistical population is spread two-dimensionally using a first threshold, and that determines, when the statistical population is spread two-dimensionally, whether or not an angle between a first plane and a second plane is small to a negligible extent using a second threshold, the first plane including a circle about which the statistical population is concentrated, and the second plane being perpendicular to a line segment connecting a center of the circle and a current offset of the magnetic data; and an offset update part that updates the current offset based on the statistical population so that the current offset moves in a direction parallel to the first plane as a result of updating, in case that the statistical population is spread two-dimensionally and the angle between the first plane and the second plane is not small to the negligible extent.

If the current offset is assumed to be the true offset, the plane about which the statistical population is concentrated is not perturbed and thus the first plane coincides with the second plane when the 3D magnetic sensor is rotating about a specific axis in a space in which external magnetic fields of the movable body are uniformly stable as long as the statistical population is not affected by any of magnetic fields generated by electronic circuits mounted in the movable body, fluctuations of outputs of the magnetic sensor according to Gaussian distribution, or the like. However, actually, the first and second planes intersect each other at a very small angle when the 3D magnetic sensor is rotating about a specific axis since the statistical population is affected by magnetic fields generated by electronic circuits mounted in the movable body, fluctuations of outputs of the magnetic sensor according to Gaussian distribution, or the like. Accordingly, in the invention, the offset is not updated such as to move toward a direction parallel to the first plane when the first and second planes intersect each other at a very small angle. Thus, according to the invention, when the magnetic sensor is rotating about a specific axis, it is possible to prevent an offset of magnetic data from being inappropriately corrected due to correction of the offset of magnetic data in the direction of the specific axis. In addition, the condition that the “statistical population is spread two-dimensionally” indicates that the statistical population is concentrated about a specific plane and that the foot of a perpendicular drawn from each magnetic data of the statistical population to the specific plane are spread widely to a certain extent and is specifically defined with reference to the first threshold. When the statistical population is spread two-dimensionally, the statistical population is concentrated about a specific circle. In addition, the condition that the angle between the first plane and the second plane is “small to a negligible extent” indicates that the angle is small to an “extent” comparative to or corresponding to an error component included in the statistical population due to magnetic fields generated by electronic circuits mounted in the movable body or due to fluctuations of outputs of the magnetic sensor according to Gaussian distribution and is specifically defined with reference to the second threshold.

(2) In the magnetic data processing device for achieving the above object, the offset update part may derive, as a candidate offset, a foot of a perpendicular drawn from the current offset to a line, which is normal to the first plane and passes through the center of the circle, and updates the current offset by the candidate offset in case that the statistical population is spread two-dimensionally and the angle between the first plane and the second plane is not small to the negligible extent.

According to the invention, it is possible to update the offset so as to approach the true offset in a direction in which the reliability of the statistical population is high.

The functions of each part described in the claims are implemented by hardware resources whose functions are specified by the configuration itself, or hardware resources whose functions are specified by a program, or a combination thereof. The functions of each part are not limited to those implemented by physically independent hardware resources. The invention may also be applied to a magnetic data processing method, a magnetic data processing program, and a machine readable storage medium containing the magnetic data processing program. Of course, the storage medium containing the magnetic data processing program may be a magnetic recording medium or a magneto-optical recording medium and may be any other recording medium developed in the future.

### BRIEF DESCRIPTION OF THE DRAWINGS

FIG. 1 is a block diagram of an embodiment of the invention.

FIG. 2 is a schematic diagram of the embodiment of the invention.

FIG. 3 is a flow chart of the embodiment of the invention.

FIG. 4 is a schematic diagram of the embodiment of the invention.

FIG. 5 is a schematic diagram of the embodiment of the invention.

FIG. 6 is a schematic diagram of the embodiment of the invention.

### DETAILED DESCRIPTION OF THE INVENTION

Embodiments of the invention will now be described with reference to the accompanying drawings. Corresponding elements in each figure will be denoted by like reference numerals and a redundant description thereof will be omitted.

### 1. OVERVIEW

In embodiments of the invention, the current offset is corrected three-dimensionally based on a recent statistical population when the distribution of magnetic data of the recent statistical population is three-dimensional. On the other hand, the current offset is corrected two-dimensionally based on the recent statistical population when the angle between a first plane including a circle about which the recent statistical population is concentrated, and a second plane which is perpendicular to a line segment connecting the center of the circle and the current offset, is not very small. The current offset is maintained as it is without correction when the distribution of magnetic data of the recent statistical population is two-dimensional and the angle between the first plane including the circle about which the recent statistical population is concentrated, and the second plane which is perpendicular to the line segment connecting the center of the circle and the current offset, is very small.

### 2. CONFIGURATION OF MAGNETIC DATA PROCESSING DEVICE

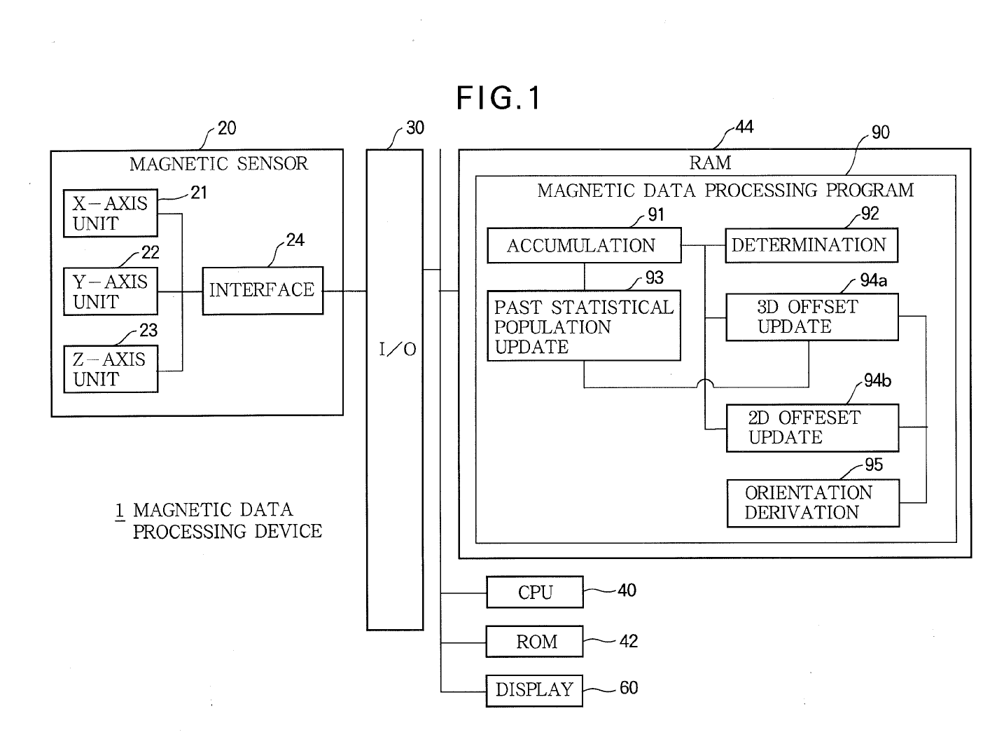

FIG. 1 is a block diagram illustrating an embodiment of a magnetic data processing device of the invention. The magnetic data processing device 1 is mounted on a portable information terminal or an in-vehicle navigation device such as a mobile phone, a Personal Navigation Device (PND), an electronic compass, or a digital camera.

The magnetic data processing device 1 includes a magnetic sensor 20 and a microcomputer. The microcomputer includes a CPU 40, a ROM 42, a RAM 44, an input/output unit (I/O) 30, and the like. The magnetic data processing device 1 receives magnetic data output from the magnetic sensor 20 and outputs orientation data to visually or audibly inform the user of a travel direction or an expected travel route based on offset-corrected magnetic data. A display unit 60 includes a display panel and a display driver for displaying an image indicating the orientation.

The magnetic sensor 20 is a 3D magnetic sensor including an x-axis sensor 21, a y-axis sensor 22, and a z-axis sensor 23, which detect three orthogonal axis components of a magnetic field vector, and an interface 24. The x-axis sensor 21, the y-axis sensor 22, and the z-axis sensor 23 each include a magnetic resistance element, a hall element, or the like and may each be any type of linear 1D magnetic sensor. The x-axis sensor 21, the y-axis sensor 22, and the z-axis sensor 23 are fixed such that sensing directions thereof are orthogonal to each other. The interface 24 receives outputs of the x-axis sensor 21, the y-axis sensor 22, and the z-axis sensor 23 through time division and performs amplification and AD conversion on the outputs of the three sensors 21, 22, and 23 to output magnetic data q=(qₓ, q_{y}, q_{z}). The magnetic data q, which is a digital signal output from the interface 24, is stored in the RAM 44 at a specific address. The ROM 42, which is a nonvolatile machine readable storage medium, stores a magnetic data processing program 90, which is loaded into the RAM 44 and executed by the CPU 40, or a variety of programs for implementing functions of the portable information terminal or the in-vehicle navigation device.

The magnetic data processing program 90 is a program for outputting orientation data based on magnetic data and is stored in the ROM 42. The orientation data is vector data indicating the direction of the Earth's magnetic field. The magnetic data processing program 90 includes a group of modules such as an accumulation module 91, a determination module 92, a past statistical population update module 93, a 3D offset update module 94a, a 2D offset update module 94b, and an orientation derivation module 95.

The accumulating module 91 is a program module that implements a function to repeatedly accumulates N magnetic data q₁, . . . , q_{N} (N≧4) as a recent statistical population while sequentially acquiring magnetic data output from the 3D magnetic sensor. That is, the accumulating module 91 implements a function to sequentially acquire magnetic data output from the magnetic sensor 20 at regular time intervals and to store the acquired magnetic data in a recent buffer. The recent buffer is a storage region provided in the RAM 44 for storing N magnetic data.

The determination module 92 is a program module that implements a function to determine, each time a recent statistical population is stored, whether or not a distribution of the recent statistical population satisfies a first condition using a threshold α while determining whether or not the distribution of the recent statistical population satisfies a second condition using a threshold β and to determine whether or not a mixed statistical population including the recent and past statistical populations satisfies a third condition using the threshold α, and a function to determine, when the distribution of the recent statistical population satisfies the second condition, whether or not an angle between a first plane including a circle about which the recent statistical population is concentrated, and a second plane which is perpendicular to a line segment connecting the center of the circle and the current offset, is small to a negligible extent using a threshold γ. Here, the thresholds α and β correspond to the first threshold described in the claims and the threshold γ corresponds to the second threshold described in the claims.

The mixed statistical population includes a set of magnetic data, which is obtained by trimming a plurality of magnetic data constituting the recent statistical population of the latest time in half in the order in which the magnetic data is acquired, and a set of magnetic data constituting the past statistical population. The past statistical population includes a recent statistical population obtained in the past and it is assumed in this embodiment that the past statistical population is a set of magnetic data obtained by trimming the recent statistical population obtained in the past in half. Since the mixed statistical population is defined as such a data set, the number of magnetic data of the mixed statistical population is equal to the number of magnetic data of the recent statistical population and therefore it is possible to apply common program code to implement functions to determine distribution characteristics of the statistical population and to derive the offset.

Here, examples of the above noted recent statistical population and past statistical population are given below for better understanding of these terms. In case that N pieces of magnetic data a q_{1′}, q_{2′} . . . , q_{N′} are sequentially accumulated, and then N pieces of magnetic data q₁, q₂ . . . , q_{N} are sequentially accumulated, the past statistical population is formed by N/2 pieces of magnetic data q_{1′}, q_{3′}, q_{5′} . . . , q_{N-1′}, which are extracted, for example, alternately from the first group of the magnetic data q_{1′}, q_{2′} . . . , q_{N′}, and the recent statistical population is formed by the newest group of the magnetic data q₁, q₂ . . . , q_{N}. In this case, the mixed statistical population is formed of the magnetic data q_{1′}, q_{3′}, q_{5′} . . . , q_{N-1′} contained in the past statistical population and N/2 pieces of magnetic data q₁, q₃, q₅ . . . , q_{N-1}, which are extracted, for example, alternately from the recent statistical population containing the magnetic data q₁, q₂ . . . , q_{N}. Therefore, the mixed statistical population is composed of N pieces of magnetic data q_{1′}, q_{3′}, q_{5′} . . . , q_{N-1′} and q₁, q₃, q₅ . . . , q_{N-1}. In the disclosed example, N/2 pieces of magnetic data are collected by extracting odd number of magnetic data from the magnetic data group containing N magnetic data. Otherwise, even number of magnetic data may be extracted to form the past statistical population or to form the mixed statistical population, or other method may be adopted to extract the magnetic data.

In this embodiment, ratios between three principal values of the distribution of a statistical population are used as indices of the distribution of the statistical population and the determination module 92 determines distribution characteristics of the statistical population by comparing each of the indices with a corresponding predetermined threshold. Specifically, the determination module 92 determines distribution characteristics of the statistical population in the following manner. Principal values of the distribution of a statistical population qᵢ, . . . , q_{N} correspond respectively to eigenvalues λ₁, λ₂, and λ₃ (λ₁≧λ₂≧λ₃) of a symmetric matrix A defined by the following equations (1), (2), and (3).

$$\begin{matrix}A = {X}^{T} X \\ where & ( 1 ) \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] & ( 2 ) \\ \overline{q} = \frac{1}{N} {\sum }_{i = 1}^{N} {q}_{i} . & ( 3 )\end{matrix}$$

In addition, λ₃/λ₁ is defined as an index indicating the extent to which the statistical population is distributed three-dimensionally. Also, λ₂/λ₁ is defined as an index indicating the extent to which the statistical population is distributed two-dimensionally. The determination module 92 determines that the statistical population is distributed three-dimensionally when λ₃/λ₁ is greater than the predetermined threshold α. That is, the determination module 92 determines that the recent statistical population satisfies the first condition and the mixed statistical population satisfies the third condition. The determination module 92 determines that the statistical population is distributed two-dimensionally when λ₃/λ₁ is not greater than the predetermined threshold α and λ₂/λ₁ is greater than the predetermined threshold β. That is, the determination module 92 determines that the recent statistical population satisfies the second condition. The symmetric matrix A corresponds to N times a variance-covariance matrix since the symmetric matrix A is also written as in Equation (4).

$$A = {\sum }_{i = 1}^{N} ( {q}_{i} - \overline{q} ) {( {q}_{i} - \overline{q} )}^{T} \qquad ( 4 )$$

In this embodiment, when the following Equation (5), which is defined using an eigenvector u₃ corresponding to the minimum principal value λ₃ of the recent statistical population, the center c of a circle about which the recent statistical population is concentrated, the current offset pₒ, and a threshold γ close to and less than 1, is satisfied, the determination module 92 determines that the angle between a first plane including the circle and a second plane which is perpendicular to a line segment connecting the center c of the circle and the current offset p₀, is small to a negligible extent.

$$\frac{\vert {( {p}_{0} - c )}^{T} {u}_{3} \vert}{‖ {p}_{0} - c ‖ ‖ {u}_{3} ‖} > γ \qquad ( 5 )$$

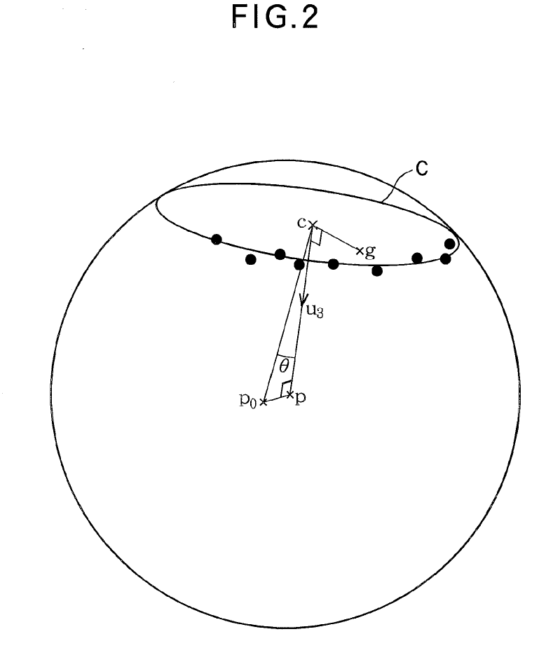

The center c of the circle, about which the recent statistical population is concentrated, is obtained in the following manner. The eigenvector u₃ corresponding to the minimum principal axis λ₃ of the recent statistical population, which is shown by black dots in FIG. 2, has a direction perpendicular to a plane including a circle C, about which the recent statistical population is concentrated. In addition, the center of the recent statistical population, which is denoted by “g” in FIG. 2, is included in the plane including the circle C, about which the recent statistical population is concentrated. Accordingly, the eigenvector u₃, the center c of the circle, and the center of the recent statistical population q₁, . . . , q_{N} (see Equation (3)) satisfy the following equation (6).

u₃^{T}( q̅−c)=0 (6)

When the foot of a perpendicular drawn from the current offset p₀ to a line, which is normal to the first plane and passes through the center c of the circle, is denoted by “p”, a real number k satisfying the following Equation (7) should exist since the line passing through “c” and “p” is parallel to the eigenvector u₃.

c=p+ku₃ (7)

When the right-hand side of Equation (7) is substituted into “c” in Equation (6), “k” is expressed as follows.

k=u₃^{T}( q̅−p) (8)

When the right-hand side of Equation (8) is substituted into “k” in Equation (7), the center c is expressed by the following Equation (9).

$$c = p + \{ {u}_{3}^{T} ( \overline{q} - p ) \} {u}_{3} \qquad ( 9 )$$

Here, “p” is a candidate offset derived by correcting the current offset two-dimensionally based on the recent statistical population. The candidate offset p for two-dimensional offset correction is derived without using the center c as described later. Accordingly, the determination module 92 determines whether or not the candidate offset p satisfies an equation obtained by substituting the right-hand side of Equation (9) into the center c in Equation (5) after the candidate offset p is derived without using the center c. In addition, the angle between the first plane and the second plane corresponds to the angle (shown by θ in FIG. 2) between a line segment connecting the center c of the circle, about which the recent statistical population is concentrated, and the current offset p₀ and another line segment connecting the center c of the circle and the candidate offset p. Accordingly, the left-hand side of Equation (5) corresponds to cos θ which is the cosine of the angle θ.

The past statistical population update module 93 is a program module that implements a function to update the past statistical population with at least a part of the recent statistical population when the recent statistical population satisfies the second condition. Specifically, when the recent statistical population satisfies the second condition, the past statistical population update module 93 trims magnetic data elements constituting the recent statistical population in half in the order in which the magnetic data elements are acquired, and stores the trimmed recent statistical population in a past buffer. The past buffer is a storage region defined in the RAM 44 for storing a predetermined number of magnetic data elements, separately from the recent statistical population.

The 3D offset update module 94a is a program module that implements a function to correct the current offset three-dimensionally based on the recent statistical population or the mixed statistical population. Specifically, the 3D offset update module 94a derives the offset in the following manner. In each equation, the recent statistical population and the mixed statistical population will each be represented by q₁, . . . , q_{N}.

When the statistical population includes four magnetic data elements that are not in the same line, a sphere on which the statistical population is distributed is uniquely specified without using a statistical method. A position vector p=(pₓ, p_{y}, p_{z}) of the center of the sphere is obtained by solving simultaneous equations (10). Although the number of equality constraints is four for three variables, the equations (10) must have a solution since one of the four equality constraints is redundant.

$$\begin{matrix}[ \begin{matrix}{( {q}_{1} - \overline{q} )}^{T} \\ {( {q}_{2} - \overline{q} )}^{T} \\ {( {q}_{3} - \overline{q} )}^{T} \\ {( {q}_{4} - \overline{q} )}^{T}\end{matrix} ] c = \frac{1}{2} [ \begin{matrix}{q}_{1}^{T} {q}_{1} - R \\ {q}_{2}^{T} {q}_{2} - R \\ {q}_{3}^{T} {q}_{3} - R \\ {q}_{4}^{T} {q}_{4} - R\end{matrix} ] \\ where & ( 10 ) \\ R = \frac{1}{N} {\sum }_{i = 1}^{N} {q}_{i}^{T} {q}_{i} & ( 11 )\end{matrix}$$

Here, if the following simultaneous linear equations (12) for “p” have a solution when the number of data elements of the statistical population is five or more, the solution is the center of the sphere on which the statistical population is distributed.

$$\begin{matrix}Xp = j , \\ where & ( 12 ) \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] . & ( 13 )\end{matrix}$$

However, the equation (12) rarely has a solution when measurement errors of the magnetic sensor 20 are taken into consideration. Thus, let us introduce a vector “e” defined as in the following equation (14) in order to obtain a feasible solution using a statistical method.

e=Xp−j (14)

The value of “p” which minimizes ∥e∥₂² (i.e., e^{T}e) is likely to be the center of a sphere, to which the statistical population is distributed closest. When the matrix A is regular, the problem of obtaining the value of “p” which minimizes ∥e∥₂² is an optimization problem of minimizing an objective function of the following Equation (15).

ƒ(p)=(Xp−j)^{T}(Xp−j) (15)

That is, the value of “p” which minimizes the objective function f(p) of Equation (15) is derived as an updated offset by correcting the current offset three-dimensionally. The value of “p” which minimizes the objective function f(p) can be written as the following Equation (16) when X^{T}X is regular as assumed in this embodiment.

p=(X^{T}X)⁻¹X^{T}j (16)

The 2D offset update module 94b is a program module that implements a function to derive a candidate offset p by correcting the current offset p₀ two-dimensionally based on the recent statistical population and to update the current offset p₀ with the derived candidate offset p when the angle between a first plane including a circle about which the recent statistical population is concentrated, and a second plane which is perpendicular to a line segment connecting the center c of the circle and the current offset p₀, is not small to a negligible extent. That is, the 2D offset update module 94b implements a function to derive the candidate offset p based on both the recent statistical population stored in the accumulating module 91 and the current offset p₀ and to update the current offset p₀ with the candidate offset p according to the determination of the determination module 92. Specifically, the 2D offset update module 94b derives the candidate offset p in the following manner.

The 2D offset update module 94b derives the candidate offset p by restricting directions in which the current offset p₀ is corrected to two orthogonal directions. In the case where the statistical population is distributed concentrating on a specific plane while being spread when viewed from a direction perpendicular to the plane, the statistical population in a direction parallel to the plane is sufficiently reliable as a data set used for offset correction while the statistical population in the direction perpendicular to the plane is unreliable. In this case, the current offset is not corrected in the direction perpendicular to the plane, thereby preventing the current offset from being updated based on unreliable information. Thus, the 2D offset update module 94b derives, as the candidate offset, the foot p of a perpendicular drawn from the current offset pₒ to a line, which is normal to the first plane and passes through the center c of the circle about which the recent statistical population accumulated in the accumulating module 91 is concentrated.

When the statistical population is concentrated about a specific plane while being spread in a direction perpendicular to the plane, the direction perpendicular to the plane is coincident with the direction of an eigenvector u₃ corresponding to the minimum eigenvalue λ₃ and two orthogonal directions parallel to the plane are coincident with the directions of eigenvectors u₁ and u₂ corresponding respectively to the maximum eigenvalue λ₁ and the intermediate eigenvalue λ₂. Accordingly, in order to derive a candidate offset p without correcting the current offset p₀ in the direction perpendicular to the plane, a candidate offset p which minimizes the objective function of Equation (15) is found under a constraint condition expressed by the following equation (17).

p=p₀+β₁u₁+β₂u₂(β₁,β₂: real numbers) (17)

Equation (17) is equivalent to the following equation (18).

u₃^{T}(p−p₀)=0 (18)

The equation for solving the optimization problem of Equation (15) under the constraint condition of Equation (17) can be modified to its equivalent simultaneous equations using the method of Lagrange multipliers. When a Lagrange undetermined multiplier ρ is introduced and “x” is defined by the following equation (19), simultaneous linear equations (20) of “x” are the same as the above-mentioned simultaneous equations.

$$\begin{matrix}x = [ \begin{matrix}p \\ ρ\end{matrix} ] & ( 19 ) \\ {B}_{4} x = {b}_{4} \\ where & ( 20 ) \\ {B}_{4} = [ \begin{matrix}A & {u}_{3} \\ {u}_{3}^{T} & 0\end{matrix} ] & ( 21 ) \\ {b}_{4} = [ \begin{matrix}{X}^{T} j \\ {u}_{3}^{T} {p}_{0}\end{matrix} ] . & ( 22 )\end{matrix}$$

The orientation derivation module 95 is a program module that generates orientation data by correcting magnetic data sequentially acquired from the magnetic sensor 20 using the current offset. Specifically, the orientation derivation module 95 outputs, as the orientation data, vector data obtained by subtracting components of the current offset from components of the magnetic data which is vector data.

### 3. MAGNETIC DATA PROCESSING METHOD

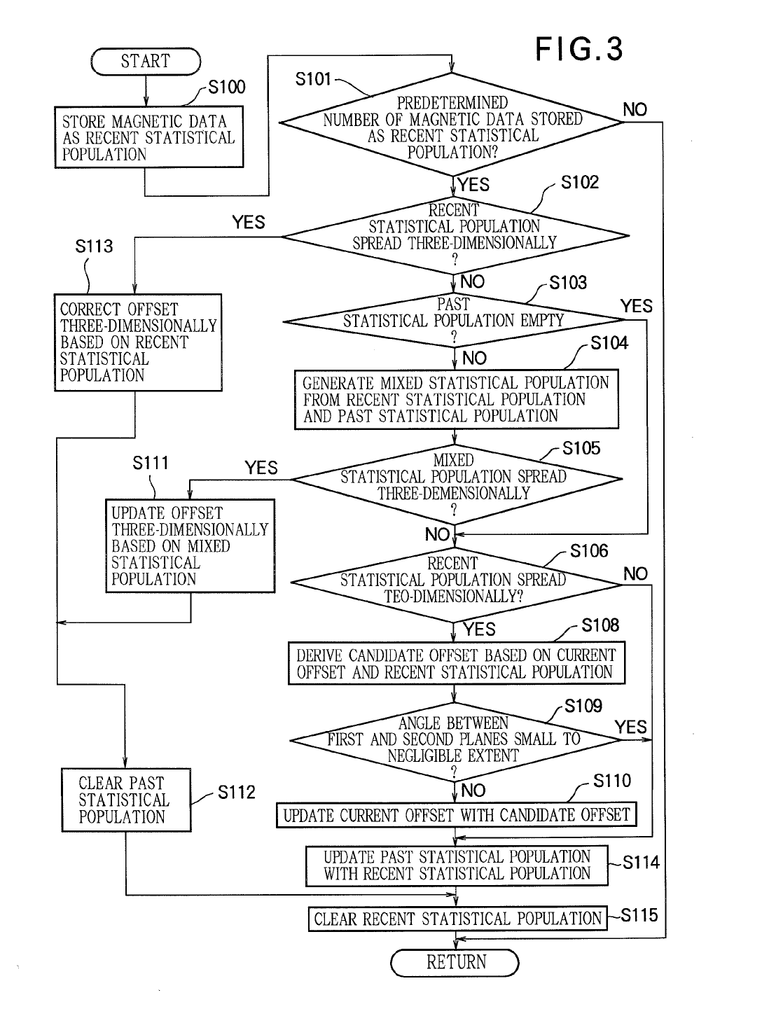

Next, a magnetic data processing method, which is implemented by executing the magnetic data processing program 90, is described with reference to FIG. 3. A procedure of FIG. 3 is repeatedly performed at regular time intervals (for example, at intervals of 10 milliseconds).

First, the accumulating module 91 acquires magnetic data output from the magnetic sensor 20 and stores the acquired magnetic data in the recent buffer (S100).

Then, the determination module 92 determines whether or not a predetermined number of magnetic data has been stored as a recent statistical population in the recent buffer (S101). When the predetermined number of magnetic data has not yet been stored as a recent statistical population in the recent buffer, next magnetic data is added to the recent buffer after a predetermined time has elapsed (S100).

When the predetermined number of magnetic data has been accumulated as a recent statistical population in the recent buffer, the determination module 92 determines whether or not the recent statistical population is spread three-dimensionally (S102).

When the recent statistical population is spread three-dimensionally, the current offset is corrected three-dimensionally based only on the recent statistical population (S113). That is, the 3D offset update module 94a corrects the current offset three-dimensionally using the magnetic data stored in the recent buffer as a statistical population.

The 3D offset update module 94a discards the past statistical population when the offset has been corrected three-dimensionally based only on the recent statistical population (S112). The purpose of this is to reduce, when the true offset has changed due to change of the magnetization status, the time during which the offset is derived based on magnetic data acquired before change of the true offset, while allowing the current offset to rapidly converge upon the changed true offset.

When the recent statistical population is not spread three-dimensionally, the determination module 92 determines whether or not the past statistical population is empty (S103).

When the past statistical population is not empty, the determination module 92 generates a mixed statistical population from both the recent statistical population and the past statistical population (S104). Specifically, magnetic data stored in the recent and past buffers are stored as a mixed statistical population in a different storage region.

When the mixed statistical population has been generated from the recent statistical population and the past statistical population, the determination module 92 determines whether or not the mixed statistical population is spread three-dimensionally (S105).

When the mixed statistical population is spread three-dimensionally, the offset is corrected three-dimensionally based only on the mixed statistical population (S111). That is, the 3D offset update module 94a derives an offset using, as a statistical population, magnetic data of both the recent statistical population of the past time and the recent statistical population of the latest time and updates the current offset with the obtained offset. The 3D offset update module 94a then discards the past statistical population when the current offset has been updated (S112).

When the past statistical population is empty or when the mixed statistical population is not spread three-dimensionally, the determination module 92 determines whether or not the recent statistical population is spread two-dimensionally (S106).

When the recent statistical population is spread two-dimensionally, a possible candidate offset is derived by correcting the current offset two-dimensionally based on the recent statistical population (S108). That is, the 2D offset update module 94b derives the solution “p” of simultaneous linear equations (20) as the candidate offset.

When the candidate offset has been derived, the determination module 92 determines whether or not the angle between a first plane including a circle c about which the recent statistical population is concentrated and a second plane which is perpendicular to a line segment connecting the center c of the circle and the current offset, is small to a negligible extent (S109). That is, since the circle c about which the recent statistical population is concentrated is obtained from Equation (9) when the candidate offset p of the simultaneous linear equations (20) has been derived, the determination module 92 determines whether or not Equation (5) is satisfied for the candidate offset p.

When the angle between the first plane and the second plane is not small to a negligible extent, the current offset p₀ is updated with the candidate offset p (S110).

When the recent statistical population is spread two-dimensionally, the past statistical population is updated with the recent statistical population, regardless of the angle between the first plane and the second plane (S114). That is, the past statistical population update module 93 selects half the magnetic data from the recent statistical population and stores the selected magnetic data in the past buffer.

Finally, the accumulating module 91 discards the recent statistical population (S115).

In the above procedure, the past statistical population is not updated if the recent statistical population is spread neither three-dimensionally nor two-dimensionally. Accordingly, the past statistical population is not updated and the offset is also not derived when the magnetic sensor 20 moves neither three-dimensionally nor two-dimensionally. Since the recent statistical population is stored as a past statistical population only when the recent statistical population is spread two-dimensionally, it is likely that the mixed statistical population including the recent statistical population and the past statistical population is spread three-dimensionally. Thus, useless offset update processes can be prevented in this embodiment.

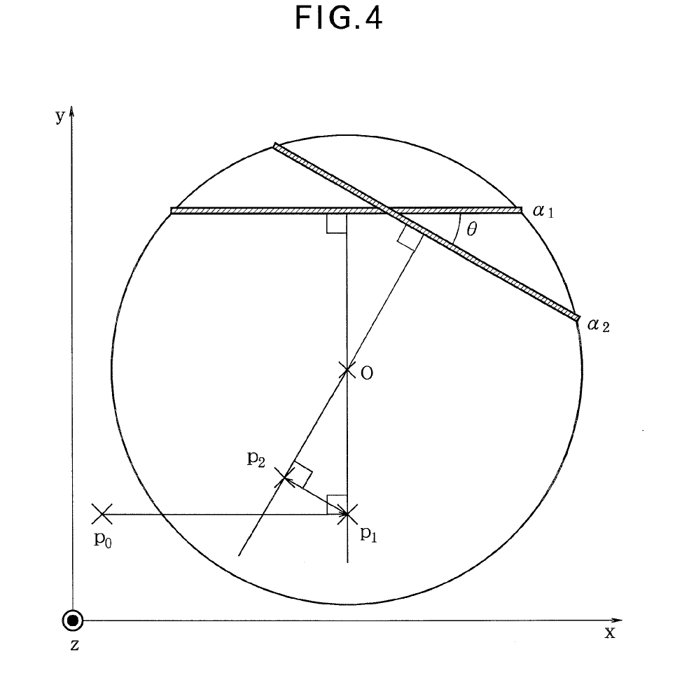

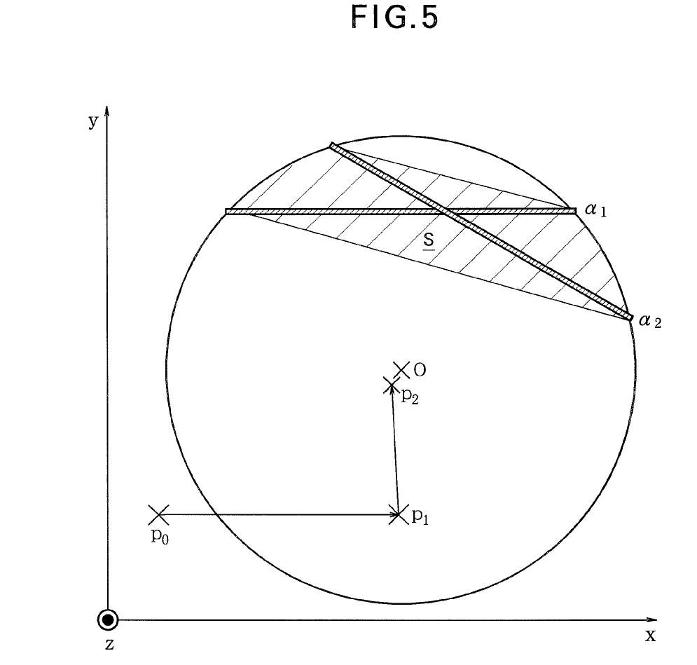

Here, let us assume that, when a plurality of statistical populations which are spread two-dimensionally has been stored, the past offset is corrected two-dimensionally based on each of the statistical populations. In this case, when the angle θ between planes α₁ and α₂ about which the statistical populations are spread is small, the current offset is sequentially updated to p₀, p₁, and p₂, hardly approaching the true offset O as shown in FIG. 4. On the other hand, in this embodiment, since the offset is derived three-dimensionally based on a three-dimensional distribution S including the planes α₁ and α₂ about which the statistical populations are spread, the offset is updated sequentially to p₀, p₁, and p₂, rapidly converging upon the true offset O, as shown in FIG. 5.

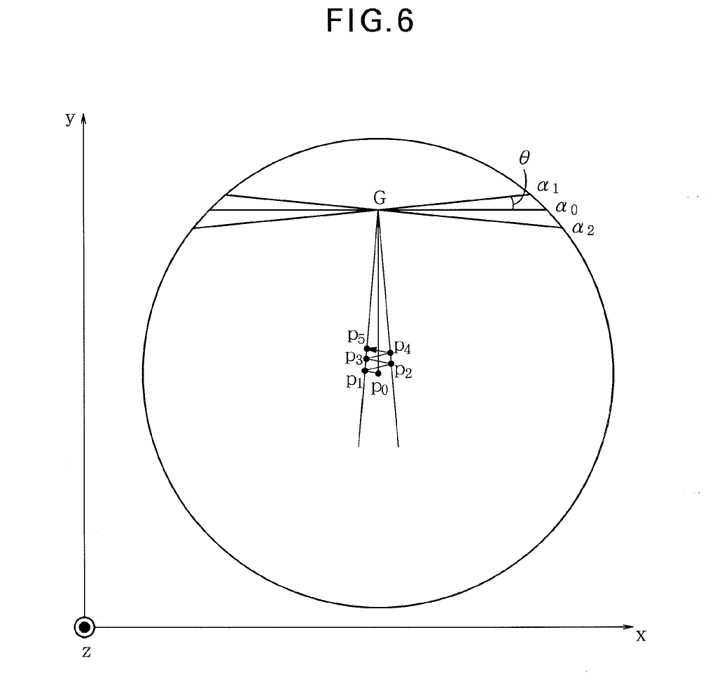

In the above procedure, the offset is not updated when the angle between a first plane including a circle about which the recent statistical population is concentrated, and a second plane which is perpendicular to a line segment connecting the center of the circle and the current offset, is small to a negligible extent. Thus, when the magnetic sensor is rotating about a specific axis, an offset of magnetic data is prevented from being inappropriately corrected due to correction of the offset of magnetic data in the direction of the specific axis. On the other hand, in the case where the current offset is corrected and updated two-dimensionally even though the angle between the first plane and the second plane is very small, the current offset continues moving toward the center of magnetic data that the magnetic data processing device acquires during rotation of the magnetic sensor 20 if the magnetic sensor 20 continues rotating about a specific axis with the true offset being constant. Here, let us assume that the current offset p₀ is equal to the true offset as shown in FIG. 6. When the magnetic sensor continues rotating about the specific axis in this state, a plane about which recent statistical populations stored during rotation are concentrated is perturbed in a small angle range, for example, in the order of α₀, α₂, α₁, α₂, α₁, and α₂, about the center G of all recent statistical populations. As a result, the current offset moves in the order of p₀, p₁, p₂, p₃, p₄, and p₅ toward the center G of all magnetic data, which the magnetic data processing device acquires during rotation, deviating from the true offset. This embodiment prevents the offset from being inappropriately corrected in this manner.

### 3. OTHER EMBODIMENTS

The scope of the invention is not limited to the above embodiments and various modifications can be made without departing from the spirit of the invention.

For example, the part for deriving the offset three-dimensionally based on a statistical population and the part for correcting the current offset two-dimensionally based on a statistical population are not limited to those described in the above embodiments, any known means may be used, and any means that will be developed in the future may also be used. Examples of the known means include a means for deriving an offset two-dimensionally or three-dimensionally using a statistical method, a means for selecting three or four magnetic data from a statistical population and obtaining, from the selected statistical population, the center of a sphere as an offset or the center of a circle as a temporary offset for correcting the current offset, etc. The present inventor has previously suggested a plurality of methods for deriving the offset of magnetic data (Japanese Patent Application Publication Nos. 2007-240270, 2007-205944, 2007-139715, 2007-107921, 2007-339478, etc).

For example, the part for determining whether or not the statistical population is spread three-dimensionally or two-dimensionally is not limited to that described in the above embodiments, any known means may be used, and any means that will be developed in the future may also be used. Examples of the known means include a means for comparing the magnitude of variance (or dispersion) of the statistical population with a threshold. Whether or not each of the past statistical population and the recent statistical population is spread three-dimensionally may be determined using an individual threshold and may also be determined using a modified algorithm.

In addition, for example, after an offset is derived based on a statistical population, the reliability of the offset may be determined using a threshold and the derived offset may be discarded when the reliability is low.

In addition, for example, the process for correcting the offset three-dimensionally based on the mixed statistical population may be omitted.

What is claimed is:

1. A magnetic data processing device comprising:
an accumulation part that repeatedly accumulates a predetermined number of magnetic data to provide a statistical population, the predetermined number being four or greater, while sequentially acquiring magnetic data output from a three-dimensional (3D) magnetic sensor;
a determination part that determines, when the predetermined number of magnetic data is accumulated as a statistical population, whether or not the statistical population is spread two-dimensionally using a first threshold, and that determines, when the statistical population is spread two-dimensionally, whether or not an angle between a first plane and a second plane is small to a negligible extent using a second threshold, the first plane including a circle about which the statistical population is concentrated, and the second plane being perpendicular to a line segment connecting a center of the circle and a current offset of the magnetic data; and
an offset update part that updates the current offset based on the statistical population so that the current offset moves in a direction parallel to the first plane as a result of updating, in case that the statistical population is spread two-dimensionally and the angle between the first plane and the second plane is not small to the negligible extent.

2. The magnetic data processing device according to claim 1, wherein the offset update part derives, as a candidate offset, a foot of a perpendicular drawn from the current offset to a line, which is normal to the first plane and passes through the center of the circle, and updates the current offset by the candidate offset in case that the statistical population is spread two-dimensionally and the angle between the first plane and the second plane is not small to the negligible extent.

3. The magnetic data processing device according to claim 1, wherein the offset update part maintains the current offset without updating the same in case that the angle between the first plane and the second plane is small to the negligible extent.

4. The magnetic data processing device according to claim 1, wherein the determination part determines whether or not the statistical population is spread three-dimensionally using a third threshold, when the predetermined number of magnetic data is accumulated as the statistical population, and the offset update part corrects the current offset three-dimensionally in case that the statistical population is spread three-dimensionally.

5. The magnetic data processing device according to claim 1, further comprising the 3D magnetic sensor.

6. A machine readable storage medium for use in a computer, the medium containing a magnetic data processing program which is executable by the computer to perform a process of:
repeatedly accumulating a predetermined number of magnetic data to provide a statistical population, the predetermined number being four or greater, while sequentially acquiring magnetic data output from a three-dimensional (3D) magnetic sensor;
determining, when the predetermined number of magnetic data is accumulated as a statistical population, whether or not the statistical population is spread two-dimensionally using a first threshold, and determining, when the statistical population is spread two-dimensionally, whether or not an angle between a first plane and a second plane is small to a negligible extent using a second threshold, the first plane including a circle about which the statistical population is concentrated, and the second plane being perpendicular to a line segment connecting a center of the circle and a current offset of the magnetic data; and
updating the current offset based on the statistical population so that the current offset moves in a direction parallel to the first plane as a result of updating, in case that the statistical population is spread two-dimensionally and the angle between the first plane and the second plane is not small to the negligible extent.

7. A magnetic data processing method comprising:
repeatedly accumulating a predetermined number of magnetic data to provide a statistical population, the predetermined number being four or greater, while sequentially acquiring magnetic data output from a three-dimensional (3D) magnetic sensor;
determining, when the predetermined number of magnetic data is accumulated as a statistical population, whether or not the statistical population is spread two-dimensionally using a first threshold, and determining, when the statistical population is spread two-dimensionally, whether or not an angle between a first plane and a second plane is small to a negligible extent using a second threshold, the first plane including a circle about which the statistical population is concentrated, and the second plane being perpendicular to a line segment connecting a center of the circle and a current offset of the magnetic data; and
updating the current offset based on the statistical population so that the current offset moves in a direction parallel to the first plane as a result of updating, in case that the statistical population is spread two-dimensionally and the angle between the first plane and the second plane is not small to the negligible extent.
